(19) United States
(12) Patent Application Publication
(10) Pub. No.: US 2025/0147350 A1
(43) Pub. Date: May 8, 2025

(54) WINDOW ASSEMBLY

(71) Applicant: William K. Boyd, Spring Lake, MI (US)

(72) Inventor: William K. Boyd, Spring Lake, MI (US)

(21) Appl. No.: 18/933,596

(22) Filed: Oct. 31, 2024

Related U.S. Application Data
(60) Provisional application No. 63/595,933, filed on Nov. 3, 2023.

(51) Int. Cl. G02F 1/133; G02F 1/1334; G02F 1/1339

(52) U.S. Cl. CPC G02F 1/13306; G02F 1/1334; G02F 1/1339

(57) ABSTRACT

A window assembly includes a windowpane, an electrically switchable film or conductive deposition or a light emitting source provided at the windowpane, a controller being in communication with a power supply and having logic, the controller being electrically coupled to the electrically switchable film or conductive deposition or light emitting source. In addition, a sensor is provided that is in communication with the controller providing input to the controller, with the sensor operable to detect motion or presence of a person or animal within a defined area around the window assembly, and the controller, using the logic, applying current from the power supply to the electrically switchable film or conductive deposition or light emitting source when the sensor detects motion or presence of a person or animal within a defined area around the window assembly.

### CROSS REFERENCE TO RELATED APPLICATION

The present application claims priority of U.S. provisional application Ser. No. 63/595,933 filed Nov. 3, 2023, which is hereby incorporated herein by reference in its entirety.

### TECHNICAL FIELD AND BACKGROUND

The present disclosure relates to window assemblies, and more specifically to window assemblies that are configured to respond to movement, such as movement of an animal or person, when in close proximity to the window assembly, for example to avoid impacts, such as animal impacts.

These and other objects, advantages, purposes and features of this invention will become apparent upon review of the following specification in conjunction with the drawings.

### SUMMARY

The present application discloses a window assembly that includes a windowpane and an electrically switchable film, or a windowpane with micro-etched glass or micro-pitted glass which acts as a light pipe, which can change the opacity of a region or regions of or the whole pane. In other forms, the window assembly may include a windowpane with one or more active light emitting sources, such as mini-LEDs, micro-LEDs, micro-LETs, nano-LEDs. In each of the above, the window assembly includes a controller that is in communication with a power supply and has logic, with the controller being electrically coupled to the electrically switchable film or deposition or light emitting source, such as LEDs.

The window assembly further includes a sensor in communication with the controller, which provides input to the controller, with the sensor being operable to detect motion or presence of an animal or person within a defined area around the window assembly. The controller, using the logic, applies current from the power supply to the electrically switchable film or deposition or the light emitting source when the motion sensor detects motion or presence of an animal or person within a defined area around the window assembly.

### BRIEF DESCRIPTION OF THE DRAWINGS

FIG. 1 is an elevation view of a window assembly;

FIG. 2 is a block diagram of the window assembly and control system;

FIG. 3 is a flow diagram of the control system;

FIG. 4 is a flow diagram of another embodiment of the control system;

FIG. 5 is a cross-section view of the window assembly;

FIG. 6 is a second cross-section view of the window assembly;

FIG. 7 is an elevation view of another embodiment of the window assembly illustrating the pane with a deposition layer, which when activated can provide power to the light emitting sources, such as micro-LEDS or LETS (enlarged for illustrative purposes only) that are not readily visible until powered; and

FIG. 8 is an elevation view of yet another embodiment of the window assembly illustrating the pane with a region with micro-etching or micro-pitting, which when lit from edge mounted light sources, such as micro-LEDS or LETS (enlarged for illustrative purposes only) can change the opacity of at least a portion of the windowpane.

### DESCRIPTION OF THE PREFERRED EMBODIMENTS

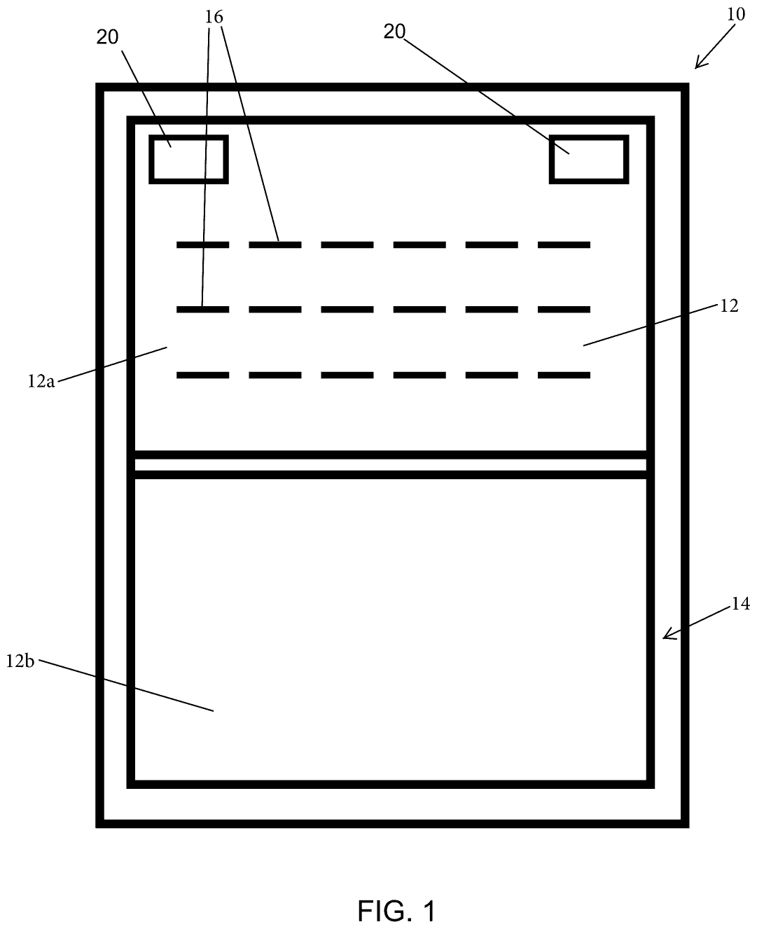

Referring to FIG. 1, the numeral 10 generally designates a window assembly that may be mounted in a building, such as a home or office building. As will be more fully described below, window assembly 10 is configured to change its transparency or to emit light when an animal, or a person, is in close proximity to the window assembly.

Referring to again to FIG. 1, window assembly 10 includes a least one windowpane 12, which may be supported in a frame 14. Windowpane 12 may be fixed or may be movable, such as in a folding window, more commonly referred to as a casement window, or in a double hung window arrangement where windowpane 12 is either an upper windowpane 12a or a lower windowpane 12b. Further, window assembly 10 may have a double or triple pane window configuration.

In one embodiment, one of the windowpanes, such as the upper windowpane 12a, includes an electrically switchable film 16 applied to the inner surface (inwardly facing into the building). For example, a suitable electrically switchable film may comprise electrochromic (“EC”) or polymer dispersed liquid crystals (“PDLC”).

Electrochromic film is a thin layer of electrochromic material laminated between two layers of ITO coated film. The electrochromic material changes between a colored, translucent state (for example blue) and a transparent state. When electricity is applied, the film changes its opacity. Only a pulse of electricity is required to change and maintain it in its opaque state. Only when a pulse of electricity with a reverse polarity will the film return to its transparent state. One suitable electrochromic film is commercially available from SAGE of Minnesota, US.

Polymer Dispersed Liquid Crystal (PDLC) film consists of micron sized droplets of liquid crystal dispersed in an optically isotropic polymer matrix. Based on the combinations of liquid crystal and polymer material, the PDLC film can be electrically switched from a light-scattering or opaque “off state” to a non-scattering or transparent “on state”. In the “off state”, the PDLC film appears milky white due to the refractive index mismatch encountered by incoming light at the liquid crystal/polymer interface.

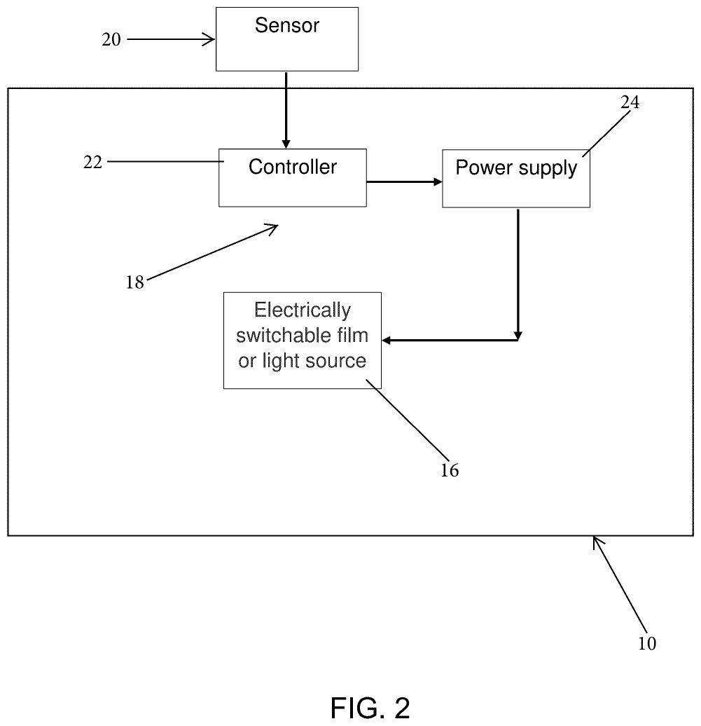

In addition, referring to FIG. 2, window assembly 10 includes a control system 18, for example mounted in the frame 14, which is in communication with the electrically switchable film 16 and is configured to change the state of the electrically switchable film 16 in response to movement or close proximity of an animal, or a person, to the window assembly. For example, the term “close proximity” may include a few inches in some applications or for moving animals a few feet to 10-15 feet.

To detect the close proximity or movement of an animal or a person, control system 18 is in communication with one or more sensors 20. Each sensor 20 may be a motion sensor or proximity sensor or any sensor that can detect movement or close proximity of an animal, or person. Additionally, in some embodiments, the sensor may comprise a camera, such as a CCD camera. Animals that can cause damage to a window assembly range in size from less than a pound to over one hundred pounds, so the type of sensor and number of sensors may vary, Further, sensor 20 may be located and mounted in the window assembly or may be remotely mounted, and either be hardwired to or communicate with control system 18 via a wireless connection—including a nearfield or infrared or conventional WIFI connection.

In the illustrated embodiment, window assembly 10 includes two sensors 20, with one sensor 20 at each upper corner of upper pane 12a.

Referring again to FIG. 2, control system 18 includes a controller 22 and an onboard power supply 24, such as a battery, capacitor, or other power storage device, Controller 22 may comprise a microprocessor-based controller, and memory, for processing instructions or for processing an algorithm stored in memory to control operation of the electrically switchable film 16 in response to the sensor 20. The controller may comprise one or more microcontrollers, field programmable gate arrays, systems on a chip, discrete circuitry, and/or other suitable hardware, software, or firmware that is capable of carrying out the functions described herein. Optionally, the power supply 24 may be separate and remote from the window assembly, such as the building power supply, which is then coupled to the control system to deliver power to the controller 22.

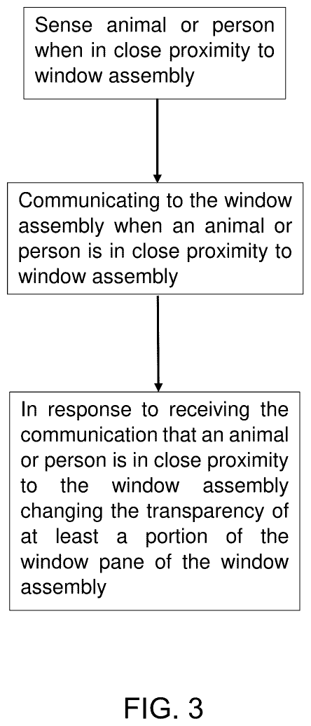

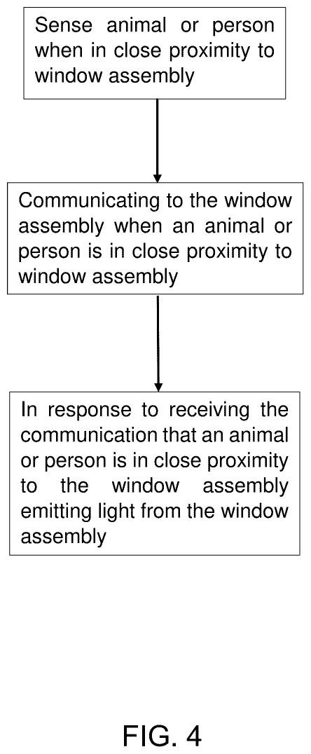

Referring to FIG. 3, when sensor or sensors 20 detect or sense movement or when an animal or person is in close proximity to window assembly 10, sensor(s) 20 generates a signal that is communicate to the controller 22 of control system 18. When controller 22 receives the signal from sensor(s) 20, controller 22 delivers a pulse of electricity to electrically switchable film 16 to cause electrically switchable film 16 to change state, e.g., from transparent to opaque.

Optionally, controller 22 may have a timer or be in communication with a timer circuit so that after a period of time has passed after electrically switchable film 16 has changed state, controller 22 will apply another pulse of electricity with a reverse polarity to electrically switchable film 16 to return electrically switchable film 16 to its previous state, e.g., from opaque to transparent. Alternately, the controller 22 may be configured to receive a signal from a handheld device, such as controller by an occupant of the building, to return the electrically switchable film 16 to its default state—such as its transparent state.

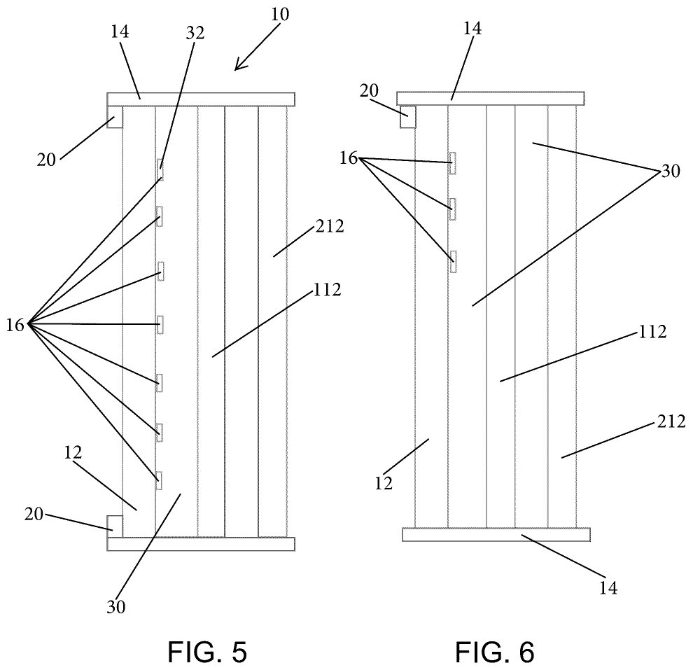

Referring to FIGS. 5 and 6, in one embodiment, window assembly 10 includes two or three spaced apart windowpanes 12, 112, 212. Further, window assembly 10 may include a spacer 30 between each pane to maintain the space between the panes and also to form a substrate for electrically switchable film 16. Spacer 30 may be a transparent material, such as a plastic material, including thermoplastic material. A suitable spacer is described in US Patent Publication 2016/0138324, which is incorporated by reference herein.

As best seen in FIG. 1, electrically switchable film 16 may be applied in one or more discrete areas on windowpane 12a. For example, the discrete areas may be dots or small regions. In one embodiment, spacer 30 includes a plurality of recesses 32 with the electrically switchable film 16 provided in each of the recesses, but interconnected electrically via electrically transmitting elements, such as wires, or electrically conductive depositions, discussed below. In this manner, when the areas of the electrically switchable film are pulsed with electricity with a first polarity they will change their state, e.g., from transparent to opaque. This results in discrete areas of the windowpane changing the pane's transparency. When pulsed with electricity with an opposite polarity, the discrete areas of electrically switchable film will again change their state back to their original state, e.g., from opaque to transparent, so that the whole pane is once again transparent.

The number and size of each electrically switchable film areas may vary depending on the application. Further, some electrically switchable film areas may be independently powered by the controller 22 so that the number of electrically switchable film areas that are pulsed can be varied by the controller to change the shape or size of the pattern formed by the electrically switchable film areas. In this manner, the total area of the pattern formed by the electrically switchable film areas can be increased or decreased by the controller 22.

Thus, when a pulse of electricity is applied by the controller 22, the electrically switchable film 16 changes the transparency of a portion or portions of the windowpane 12a wherein the change of transparency of electrically switchable film is confined to only to small regions of the windowpane 12a, while also leaving windowpane 12b transparent.

In alternate embodiment, the entire windowpane 12a and optionally windowpane 12b may be entirely covered with the electrically switchable film, which maybe similarly powered by the controller as described above.

Thus, the electrically switchable film forms a passive system and relies on reflection to deter an animal or person from causing impact with the window assembly.

In yet another embodiment, window assembly 10 may incorporate an active system, such as one or more light emitting sources, such as light emitting transistors (LET), light emitting diodes (LED), including micro LETs, mini LEDs, nano-LEDS, or micro LEDs, which are controlled and selectively powered by controller 22 based on the input from sensor(s) 20. The light emitting sources may be surface mounted to the windowpane or edge mounted to direct light into the edge or edges of the windowpane. For example, when surface mounted, a plurality of the light emitting sources may be mounted around the perimeter of pane 12a, adjacent each edge of pane 12a and inwardly of the frame. Alternately, the light emitting sources may be mounted to the frame immediately adjacent the pane. In some embodiments because of their size (e.g., in the case of the micro-LEDS or nano-LEDS,), they may be surface mounted anywhere on the pane but will not be visible until powered. It should be understood that other locations not expressly described herein are also suitable. When surface mounted, the light emitting sources may be mounted to direct light outwardly from the window assembly (and hence outwardly from the building).

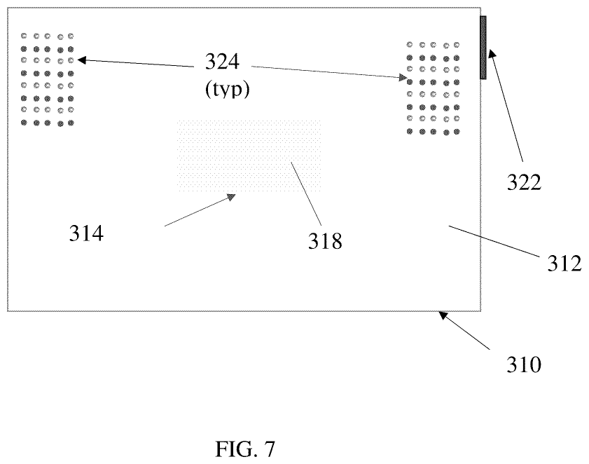

For example, as best seen in FIG. 7, in another embodiment, window assembly 310 includes at least one windowpane 312 with at least one active conductive deposition 314 that is mounted, such as by surface deposition, to the pane (outside or inside surface of the pane). In the illustrated embodiment, active conductive deposition 314 is coupled to the one or more light sources noted below and to controller 322. When powered, active conductive deposition 314 can therefore supply power to the one or more light sources, When formed from ITO, active conductive deposition 314 may be deposited so that the deposition is essentially transparent when deposited, Thus, when using micro LEDs or LETs and an ITO conductive deposition, none of the light sources or their electrical supply circuitry is readily visible until the light sources are powered. Even then only the light source then become visible to provide their active deterrence function.

As best seen in FIG. 7, and as noted, window assembly 310 may also include at least one active light emitting source 324 that is surface mounted to the windowpane. In the illustrated embodiment, window assembly 310 includes a plurality of light emitting sources 324 arranged in one or more arrays. Suitable light sources include light emitting diodes (LED) or light emitting transistors (LET), such as mini LEDs, nano-LEDS, micro LEDs or micro LETs, which are coupled to the conductive deposition 314, which in turn is coupled to controller 322 and controlled by controller 322. When formed from micro LETs or micro LEDS, as noted, the light sources may not be readily visible.

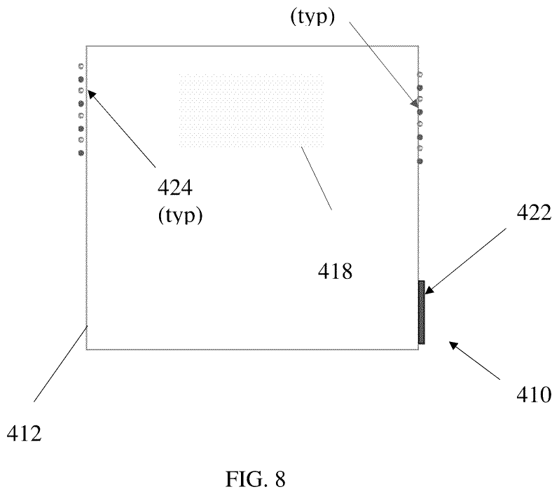

In another example, such as shown in FIG. 8, window assembly 410 may include one or more regions 418 with a micro-surface treatment, such as micro-etching or micro-pitting. The micro-treatment is effectively invisible unless side lit by a light source. Or stated in another way, the regions of micro-treatment of the windowpane are clear until light from the light emitting sources is reflected by the micro-structures formed on the windowpane. To that end, window assembly 410 includes one or more active side-lit light emitting sources 424 mounted to the windowpane, for example to the edge of the windowpane. When activated, the light emitting source 424 causes the micro-structures to reflect light in controlled areas.

In any of the above, the light emitting sources may emit light in the visible light spectrum or may emit light in the infrared region. Further, the number of light emitting sources may vary depending on the size of the window. As noted, the light sources may be mounted adjacent each edge or just one edge, but with each respective edge (whether surface mounted or edge mounted) optionally including a plurality of light emitting sources. Further, in some cases, as noted, the light emitting sources are sufficiently small so that they are not visible except when powered.

Changes and modifications in the specifically described embodiments can be carried out without departing from the principles of the present invention which is intended to be limited only by the scope of the appended claims, as interpreted according to the principles of patent law including the doctrine of equivalents.

I claim:

1. A window assembly comprising:
a windowpane;
an electrically switchable film or conductive deposition or a light emitting source provided at said windowpane;
a controller being in communication with a power supply and having logic, said controller being electrically coupled to said electrically switchable film or conductive deposition or said light emitting source; and
a sensor in communication with said controller providing input to said controller, said sensor operable to detect motion or presence of a person or animal within a defined area around said window assembly, and said controller, using said logic, to apply current from said power supply to said electrically switchable film or conductive deposition or said light emitting source when said sensor detects motion or presence of a person or animal within a defined area around said window assembly.

2. The window assembly according to claim 1, further comprising a frame supporting said windowpane.

3. The window assembly according to claim 1, wherein said windowpane comprises a first windowpane, further comprising a second windowpane supported in a spaced relationship from said first windowpane to form a space there between.

4. The window assembly according to claim 3, further comprising a spacer located in said space to maintain the first and second windowpanes in their spaced relationship, and said spacer comprising a transparent material,

5. The window assembly according to claim 1, wherein said spacer includes a plurality of recesses to form a plurality of discrete areas, wherein said electrically switchable film or conductive deposition or said light emitting source is said electrically switchable film, and said electrically switchable film provided in each of said discrete areas.

6. The window assembly according to claim 1, wherein said logic applies the current from said power circuit to said electrically switchable film or conductive deposition or said light emitting source for a predetermined period of time in response to said motion sensor sensing motion within the defined area.

7. The window assembly according to claim 1, wherein said sensor senses motion within 10 feet of the window assembly.

8. The window assembly according to claim 1, wherein said sensor is mounted in said window assembly.

9. The window assembly according to claim 3, wherein said electrically switchable film or conductive deposition or said light emitting source is said electrically switchable film, and wherein said electrically switchable film changes the transparency of a portion or portions of said first windowpane when a current is applied to said electrically switchable film, and said windowpane having an area free of said electrically switchable film wherein said electrically switchable film is confined to only a portion of said first windowpane.

10. The window assembly according to claim 1, wherein said electrically switchable film or conductive deposition or said light emitting source is said light emitting source, and said light emitting source comprising a light emitting transistor (LET) or a light emitting diode (LED).

11. A window assembly comprising:
first and second windowpanes supported by the frame in a spaced relationship to form a space there between;
a spacer located in said space to maintain the first and second windowpanes in their spaced relationship, and said spacer comprising a transparent material; and
an electrically switchable film provided at said spacer;
a power supply;
a controller having logic and being in communication with said power supply and said electrically switchable film; and
a sensor in communication with said controller and providing input to said controller, said sensor to detect when an animal is within a defined area around said window assembly, and said controller applying electrical current to said electrically switchable film when said sensor detects when an animal is within a predefined area around said window assembly.

12. The window assembly according to claim 11, further comprising a spacer located in said space to maintain the first and second windowpanes in their spaced relationship, and said spacer comprising a transparent material.

13. The window assembly according to claim 11, wherein said logic applies the current from said power supply to said electrically switchable film for a predetermined period of time in response to said sensor sensing detecting when an animal is within the predefined area.

14. The window assembly according to claim 11, wherein said sensor comprises a motion sensor mounted in said window assembly.

15. The window assembly according to claim 11, wherein said electrically switchable film changes the transparency of a portion or portions of said first windowpane when a current is applied to said electrically switchable film, and said first windowpane having an area free of said electrically switchable film wherein said electrically switchable film is confined to only a portion of said first windowpane.

16. The window assembly according to claim 11, wherein said sensor comprises a camera.

17. The window assembly according to claim 11, wherein said sensor communicates with said controller via a wireless connection.

18. The window assembly according to claim 11, wherein the predefined area is adjustable.

19. The window assembly according to claim 11, wherein said electrically switchable film comprises an electrochromic film or a polymer displacement liquid crystal (PDLC).
